(19) United States
(12) Patent Application Publication
(10) Pub. No.: US 2017/0262213 A1
(43) Pub. Date: Sep. 14, 2017

(54) CONTENTS MANAGING DEVICE

(71) Applicant: Onkyo Corporation, Osaka (JP)

(72) Inventor: Honami HIRATA, Osaka (JP)

(21) Appl. No.: 15/451,537

(22) Filed: Mar. 7, 2017

(30) Foreign Application Priority Data
Mar. 11, 2016 (JP) 2016-047928

(51) Int. Cl. G06F 3/06

(52) U.S. Cl. CPC G06F 3/0643; G06F 3/0604; G06F 3/061; G06F 3/0647; G06F 3/067

(57) ABSTRACT

To be able to detect a content even if the content is downloaded in an external storage device without free writing authority.

A PC 1 includes a USB I/F 8 that is for communicating with a DAP 101 and a CPU 2. A content is downloaded in a storage section 103 that the DAP 101 has or a memory card 104 or 105. A relative path of a folder in which the downloaded content is stored is written in a setting file. The CPU 2 detects the setting file. And, the CPU 2 detects the content based on the relative path file that is written in the detected setting file.

### BACKGROUND OF THE INVENTION

1. Field of the Invention

The present invention relates to a contents managing device that manages contents.

2. Description of the Related Art

There is a contents managing program that makes a personal computer (hereinafter, referred as to “PC”) function as a contents managing device that manages contents such as music, still images, and moving images (For example, see JP 2009-245587 A.). The contents managing program manages the contents stored in the PC. Further, the contents managing program manages contents stored in a digital audio player (hereinafter, referred as to “DAP”) that is connected to the PC.

When the contents are downloaded in the DAP via a network, the contents managing program can detect those contents. As conventional technique, there is a method that reckons a folder as a folder of interest when detection is performed, by setting the folder to which the contents desired to be detected is downloaded with a specific name. However, in this method, when folders in a storage are many in number, time needs for detection. Further, a folder name of download destination must be a specific name. For this reason, a user cannot designate an existing optional folder as the download destination.

The DAP has free writing authority against an internal storage (storage device). There are cases where the DAP does not have free writing authority against an external storage (external storage device) such as microSD card. Herein, to resolve the above mentioned problem, it is thought that a path file in which a path to be detected is written is made, and the path file is stored in specific place of a storage in which content is downloaded. However, there is a problem that the path file cannot be stored in case a storage in which content is downloaded is the external storage.

### SUMMARY OF THE INVENTION

An objective of the present invention is to detect content even if content is downloaded in an external storage device without free writing authority.

A contents managing device comprising: a communication interface that is for communicating with an external device; and a first controller, wherein a content is downloaded in a storage device that the external device includes or an external device and is stored in a folder, a relative path of the folder is written in a path file, and the first controller detects the path file and detects the content based on the relative path that is written in the detected path file.

In the present invention, a content is downloaded in a storage device that the external device includes or an external device and is stored in a folder. A relative path of the folder is written in a path file. The first controller detects the content based on the relative path that is written in the detected path file. Thus, even if the content is downloaded in the external storage device without free writing authority, the content can be detected. Further, the path file can be detected by referring a specific place in which the path file is stored and the contents can be detected in a short time. Further, it is not necessary to limit a folder name in which a detecting content is stored

Preferably, further comprising: a storage section, wherein the first controller stores the detected content in the storage section.

In the present invention, the first controller stores the detected content in the storage section. Thus, even if the content is downloaded in the external storage device without free writing authority, the content can be transferred (copied) to a contents managing device from an external device.

Preferably, wherein the first controller refers to a storage place of the path file of either of the storage device and the external storage device in turn.

In the present invention, the first controller refers to a storage place of the path file of either of the storage device and the external storage device in turn. Thus, the path file that is stored in the storage device can be detected.

An electronic device comprising: a network interface that is for communicating with an external server; a storage device; and a second controller, wherein the second controller downloads a content from the external server, and stores the downloaded content in a folder, a relative pass of the folder of the storage device or an external storage device in which the content is stored is written in a path file, the second controller makes the path file and stores the made path file in the storage device.

In the present invention, a relative pass of the folder of the storage device or an external storage device in which the content is stored is written in a path file. The second controller makes the path file and stores the made path file in the storage device. Thus, a contents managing device can detect the path file and detects the content. Therefore, according to the present invention, even if the content is downloaded in the external storage device without free writing authority, the content can be detected.

Preferably, wherein the second controller receives designation of a folder to store a downloading content in, and stores the downloaded content in the folder that designation is received.

In the present invention, the second controller receives designation of a folder to store a downloading content in, and stores the downloaded content in the folder that designation is received. For this reason, a user can download the content in a desired folder.

A contents managing system comprising: the contents managing system and the electronic device.

A storage medium in which a contents managing program is stored, the contents managing program allows a first processor of a computer including a communication interface that is for communicating with an external device and the first processor to detect a path file and to detect a content based on a relative path that is written in the detected path file, wherein the content is downloaded in a storage device that the external device includes or an external device and is stored in a folder, and the relative path of the folder is written in the path file.

According to the present invention, even if the content is downloaded in the external storage device without free writing authority, the content can be detected.

### BRIEF DESCRIPTION OF THE DRAWINGS

FIG. 1 is a block diagram illustrating a constitution of a content managing system according to an embodiment of the present invention.

FIG. 2 is a flow chart illustrating processing operation in the case where a DAP downloads content from an external server.

FIG. 3 is a flow chart illustrating processing operation in the case where a PC detects content that is downloaded to the DAP.

### DETAILED DESCRIPTION OF THE PREFERRED EMBODIMENTS

### (Contents Managing System)

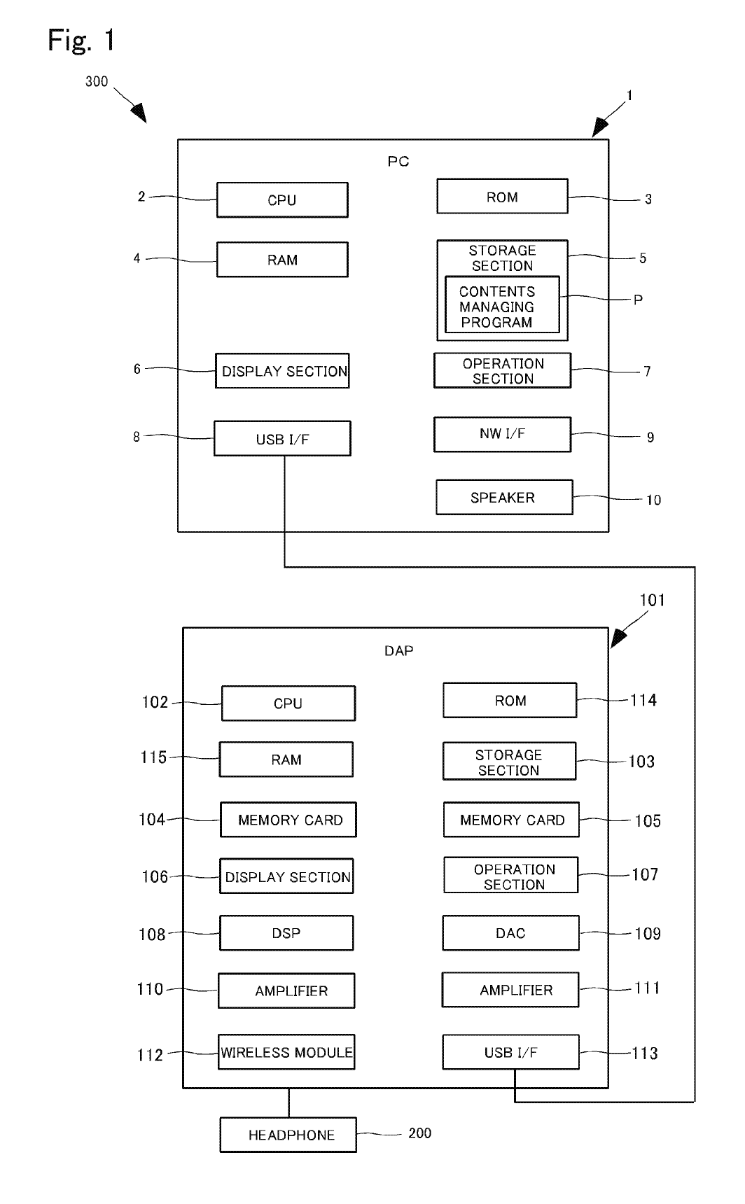

An embodiment of the present invention is described below. FIG. 1 is a block diagram illustrating a constitution of a contents managing system 300 according to an embodiment of the present invention. The content managing system 300 includes a personal computer (hereinafter, referred as to “PC”) 1 that functions as a contents managing device and a digital audio player 101 (hereinafter, referred as to “DAP”).

### (PC)

The PC 1 functions as a contents managing device by executing a contents managing program P that is stored in a storage section 5. The PC 1 includes a CPU (Central Processing Unit) 2, a ROM (Read Only Memory) 3, a RAM (Random Access Memory) 4, the storage section 5, a display section 6, an operation section 7, a USB interface (hereinafter, referred as to “USB I/F”) 8, a network interface (hereinafter, referred as to “NW I/F”) 9, and a speaker 10. The contents managing program P may be stored in the storage section 5 of the PC 1 at a time of shipment from a factory, and may be downloaded from a server (not shown) via the NW I/F 9 (described later) and stored in the storage section 5 of the PC 1.

The CPU 2 (first controller) controls respective sections composing the PC 1 according to a control program, an OS (Operating System) program, and application programs including a contents managing program P.

The ROM 3 stores the control program. The RAM 4 functions as a main memory of the CPU2. The storage section 5 is an HDD (Hard Disk Drive) that stores programs such as the OS program and application programs including the contents managing program P and contents such as music, still images and moving images. The storage section 5 is not limited to the illustrated constitution, and may be an SSD (Solid State Disc).

The display section 6 displays various images (including still images and moving images) and is a liquid crystal display. The operation section 7 is composed of a keyboard and a mouse, and is for performing various settings and transfer direction of contents. A user can execute the contents managing program P and perform transfer direction of contents to the DAP 101 via the operation section 7. The USB I/F 8 (communication interface) is an interface for performing communication corresponding to USB standard with the DAP 101. The PC 1 can communicate with the DAP 101 via the USB I/F 8. The NW I/F 9 is an interface for connecting to the Internet via network (not shown). The PC 1 can communicate with the other terminals via the NW I/F 9. The speaker 10 outputs various audio such as music based on an audio signal that is output from the CPU 2.

### (DAP)

The DAP 101 (electronic device, external device) outputs analog audio data to a headphone 200. The headphone 200 outputs an audio to external based on the analog audio data. The DAP 101 includes a CPU 102, a ROM 114, a RAM 115, a storage section 103, memory cards 104 and 105, a display section 106, an operation section 107, a DSP (Digital Signal Processor) 108, a D/A converter (hereinafter, referred to “DAC”) 109, amplifiers 110 and 111, a wireless module 112, and a USB interface (hereinafter, referred as to “USB I/F”) 113.

The CPU 102 (second controller) controls respective sections composing the DAP 101 according to a control program, an OS (Operating System) program, and application programs. The ROM 114 stores the control program. The RAM 115 functions as a main memory of the CPU 102. The storage section 103 (storage device) is a flash memory that stores programs such as the OS program and application programs and various data such as contents. The storage section 103 is not limited to the illustrated constitution, and may be an HDD (Hard Disk Drive).

The memory cards 104 and 105 (external storage device) store contents. Each of the memory cards 104 and 105 is a micro SD card, for example. Herein, the DAP 101 mounts Android (registered trademark) OS. For this reason, there is not free writing authority against the memory cards 104 and 105. Meanwhile, there is free writing authority against the storage section 103. The storage section 103, and the memory cards 104 and 105 are sometimes called “storage”. There are cases where a device has free writing authority depending on OS version even if Android (registered trademark) OS is mounted.

The display section 106 displays various images (include still images and moving images), and is composed of a liquid crystal panel. The operation section 107 has operation keys for performing various settings, and a touch panel that is linked with the display section 106. A user can input various characters and perform setting via the operation section 107. Further, the user can download contents from an external server via the operation section 107. Downloaded contents are stored in a storage of either of the storage section 103, and the memory cards 104 and 105.

The DSP 108 performs signal processing such as equalizing to digital audio data (contents). The DAC 109 D/A-converts digital audio data into analog audio data. Each of the amplifiers 110 and 111 amplifies the analog audio data that the DAC 109 D/A-converts and outputs amplified analog audio data to the headphone 200. The wireless module 112 (network interface) is for performing wireless communication according to Bluetooth (registered trademark) standard and Wi-Fi standard. The DAP 101 can communicate with the external server via the wireless module 112. The USB I/F 113 is for performing communication according to USB standard. The DAP 101 can communicate with the PC 1 via the USB I/F 113.

The PC 1 manages content that are stored in the storage section 103 and the memory cards 104 and 105. The PC 1 and the DAP 101 are connected by a USB cable.

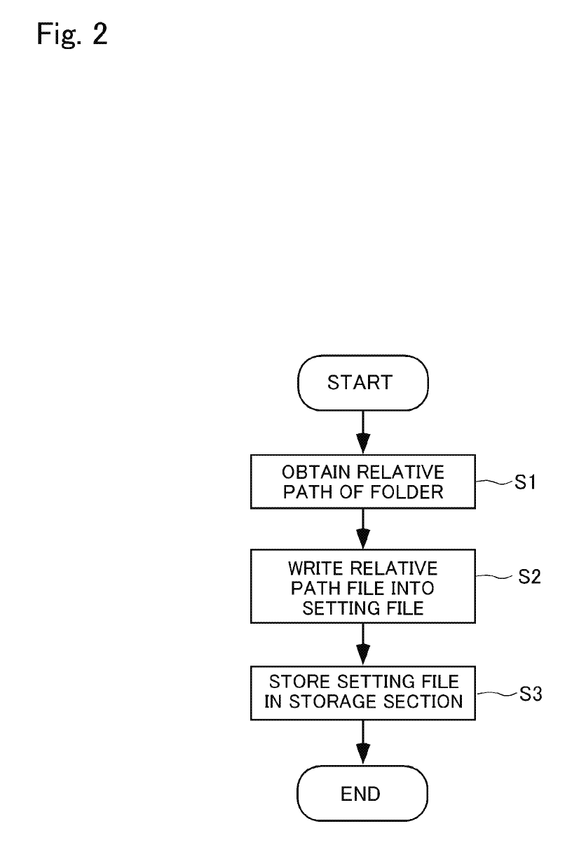

Next, processing operation in the case where a DAP 101 downloads a content from an external server is described based on a flow chart illustrated in FIG. 2. The CPU 102 obtains a relative path of a folder which is desired to be detected by the PC 1 (S1). The folder that is detected by the PC1 is a folder either of the storage section 103 and the memory cards 104 and 105 that the CPU 2 downloads the content via the wireless module 112 and stores the downloaded content in. Herein, the CPU 102 receives designation of a folder to store the downloading contents in from the external server. The user can designate the folder to store the downloading content in by the operation section 107. The CPU 102 stores the content in the folder that designation is received. The CPU 102 writes the obtained relative path into a setting file (path file) (S2). The CPU 102 stores the setting file in the predetermined place (storage place) of the storage section 103 (S3). The relative path is “A music/DL”, for example.

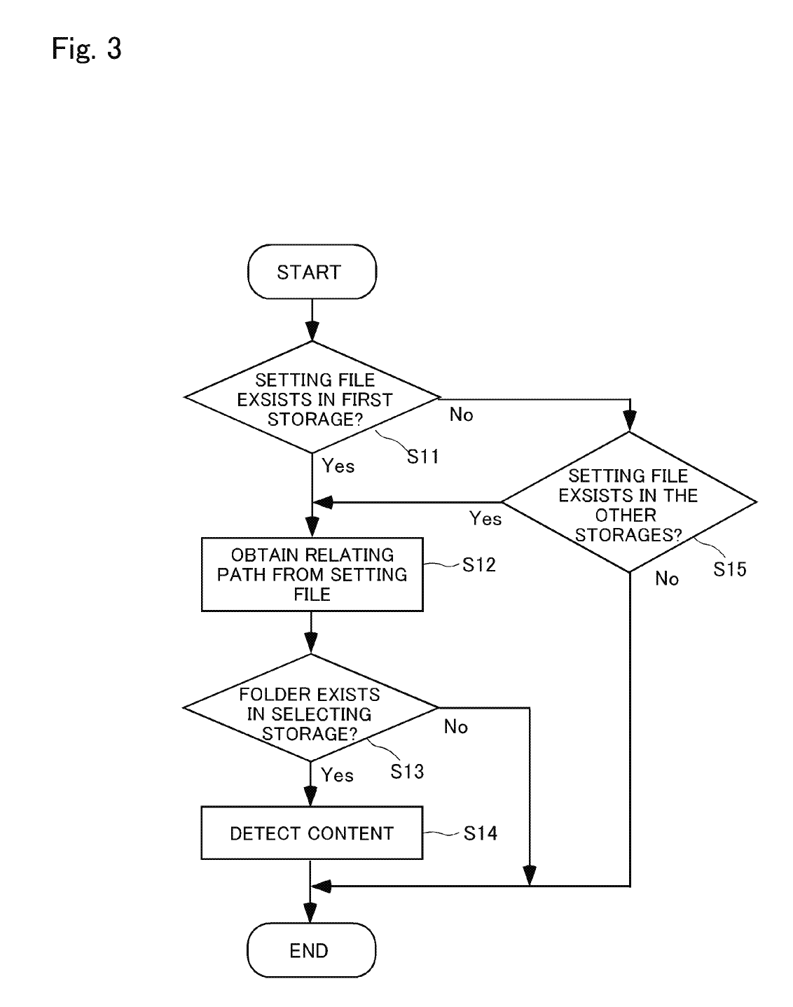

Next, processing operation in the case where PC1 detects a content that is downloaded in the DAP 101 is described based on a flow chart illustrated in FIG. 3. The CPU 2 judges whether the setting file exists or not in a first storage of the DAP 101 (S11). Concretely, in the first storage, the CPU 2 refers to a specific place that the DAP 101 stores the setting file in, and judges whether the setting file exists or not. In case that the CPU 2 judges that the setting file exists in the first storage (S11: Yes), it obtains the relative path from the setting file (S12). The CPU 2 judges whether a folder of the relative path exists or not in a selecting storage (S13). Concretely, the CPU 2 refers to the relative path in the selecting storage, and judges whether the folder of the relative path exists or not.

In case that the CPU 2 judges that the folder of the relative path exists in the selecting storage (S13: Yes), it detects a content that is added in the folder of the relative path newly (S14). The CPU 2 stores the detected content in the storage section 3.

In case that the CPU 2 judges that the setting file does not exist in the first storage (S11: No), it judges whether the setting file exists or not in the other storages (S15). Namely, the CPU 2 refer to the setting file that exists in the specific place in turn from the first storage. In case the CPU 2 judges that the setting file exists in the other storages (S15: Yes), it executes processing of S12. In case the CPU 2 judges that the setting file does not exists in the other storages, (S15: No) it ends processing because a folder in which the downloaded content is stored does not exist in the DAP 101. Further, when the CPU 2 judges that the folder of the relative path does not exist in the selecting storage (S13: No), it ends processing because the folder in which the downloaded content is stored exists in the other storage.

As described in above, in the present embodiment, the content is downloaded in the storage section 103 that the DAP 101 includes or an the memory card 104 or 105 is stored in the folder. The relative path of the folder is written in the path file. The CPU 2 detects the content based on the relative path that is written in the detected setting file. Thus, even if the content is downloaded in the memory card 104 or 105 without free writing authority, the content can be detected. Further, the setting file can be detected by referring the specific place in which the setting file is stored and the content can be detected in a short time. Further, it is not necessary to limit a folder name in which the detecting content is stored.

Further, in the present embodiment, the CPU 2 stores the detected content in the storage section 5. Thus, even if the content is downloaded in the memory card 104 or 105 without free writing authority, the content can be transferred (copied) to the PC 1 from the DAP 101.

Further, in the present embodiment, the CPU 2 refers to the storage place of the setting file from either of the storage section 103 and the memory cards 104 and 105 in turn. Thus, the setting file that is stored in the storage section 103 can be detected.

In the present embodiment, the relative pass of the folder of the storage section 103 or the memory card 104 or 105 in which the content is stored is written in the setting file. The CPU 2 makes the path file and stores the made setting file in the storage device 103. Thus, the PC 1 can detect the path file and detect the content. Therefore, according to the present embodiment, even if the content is downloaded in the memory card 104 or 105 without free writing authority, the content can be detected.

Further, in the present embodiment, the CPU 102 receives designation of the folder to store the downloading content in, and stores the downloaded content in the folder that designation is received. For this reason, the user can download the content in a desired folder.

The embodiment of the present invention is described above, but the mode to which the present invention is applicable is not limited to the above embodiment and can be suitably varied without departing from the scope of the present invention.

In the above embodiment, the DAP 101 is illustrated as an electronic device. Not limited to this, if an electronic device can download contents from the external server, the electronic device may be a smartphone or a tablet.

The present invention can be suitably employed in a contents managing device that manages contents.

1. A contents managing device comprising:
a communication interface that is for communicating with an external device to which an external storage device is connected; and
a first controller, wherein
a content is downloaded in a storage device that the external device includes or the external storage device and is stored in a folder,
a relative path of the folder is written in a path file, and
the first controller detects the path file and detects the content based on the relative path that is written in the detected path file.

2. The contents managing device according to claim 1,
further comprising: a storage section, wherein
the first controller stores the detected content in the storage section.

3. The contents managing device according to claim 1,
wherein the first controller refers to a storage place of the path file of either of the storage device and the external storage device in turn.

4. An electronic device comprising:
a network interface that is for communicating with an external server;
a storage device;
an external storage device; and
a second controller, wherein
the second controller downloads a content from the external server, and stores the downloaded content in a folder,
a relative path of the folder of the storage device or the external storage device in which the content is stored is written in a path file,
the second controller makes the path file and stores the made path file in the storage device.

5. The electronic device according to claim 4, wherein the second controller receives designation of a folder to store a downloading content in, and stores the downloaded content in the folder that designation is received.

6. A contents managing system comprising: a contents managing device comprising: a communication interface that is for communicating with an external device to which an external storage device is connected; and
a first controller, wherein
a content is downloaded in a storage device that the external device includes or the external storage device and is stored in a folder,
a relative path of the folder is written in a path file, and
the first controller detects the path file and detects the content based on the relative path that is written in the detected path file, and
the electronic device according to claim 4.

7. A storage medium in which a contents managing program is stored, the contents managing program allows a first processor of a computer including a communication interface that is for communicating with an external device to which an external storage device is connected and the first processor to detect a path file and to detect a content based on a relative path that is written in the detected path file,
wherein the content is downloaded in a storage device that the external device includes or the external storage device and is stored in a folder, and
the relative path of the folder is written in the path file.
